(19) United States
(12) Patent Application Publication
(10) Pub. No.: US 2017/0315982 A1
(43) Pub. Date: Nov. 2, 2017

(54) METHOD, DEVICE AND MOBILE TERMINAL FOR WEBPAGE TEXT PARSING

(71) Applicant: GUANGZHOU UCWEB COMPUTER TECHNOLOGY CO., LTD., Guangzhou (CN)

(72) Inventors: Chao ZHOU, Guangzhou (CN); Yongming HE, Guangzhou (CN); Liqiong HU, Guangzhou (CN)

(21) Appl. No.: 15/523,626

(22) PCT Filed: Aug. 7, 2015
(86) PCT No.: PCT/CN2015/086389

§ 371 Date: May 1, 2017

(30) Foreign Application Priority Data
Oct. 31, 2014 (CN) 201410605789.3

(51) Int. Cl. G06F 17/27; G06F 17/22; G06F 17/30; G06F 9/44; H04M 1/725

(52) U.S. Cl. CPC G06F 17/272; G06F 17/30896; G06F 9/4428; G06F 17/2247; H04M 1/72561

(57) ABSTRACT

The present disclosure provides method, device and mobile terminal for webpage text parsing. The method includes: after a webpage element is parsed into a common JavaScript script, loading the common JavaScript script, and simultaneously constructing a DOM tree node corresponding to the common JavaScript script. The common JavaScript script is executed, after loading of the common JavaScript script is completed; and the next webpage element may then be parsed, after construction of the DOM tree node corresponding to the common JavaScript script is completed. While loading and executing the common JavaScript script, construction of the DOM tree node corresponding to the common JavaScript script and parsing of the next webpage element are still continued to accelerate webpage text processing. This reduces the time of parsing, loading, rendering, and displaying the whole webpage, and also allows the elements after the common JavaScript script element to be rendered and displayed in advance.

### FIELD OF THE DISCLOSURE

The present disclosure relates to the field of mobile communication technology and, more particularly, relates to method, device, and mobile terminal for webpage text parsing.

### BACKGROUND

When a browser renders a webpage, a webpage text is first parsed into a DOM tree, and then the webpage is rendered according to the DOM tree. Webpage resources that can affect webpage rendering timing mainly include outreached CSS style files and JavaScript script files. Because CSS style files affect webpage rendering results, current mainstream browsers need to await a completion of loading of the CSS style files and then can initiate a rendering process. JavaScript script file, currently includes three types of JavaScript script file, including a <script>element having a “defer” attribute, a <script>element having an “async” attribute, and a common <script>element. FIG. 1A, FIG. 1B, and FIG. 1C show different standard timings that reveal the relationship among parsing, loading and executing scripts in a current browser for JavaScript script files:

FIG. 1A illustrates a conventional processing timing diagram of a common JavaScript script.

In FIG. 1A, line 1 represents a timeline of parsing a webpage text, line 2 represents a timeline of loading a common <script>element, and line 3 represents a timeline of executing a common <script>element.

As shown in FIG. 1A, a processing <script>of the common JavaScript script is also known as a synchronously-executed <script>element, which is a default processing behavior of <script>element. When the script is being loaded and executed, the parsing process of an HTML document is suspended. After an execution of loading of the current <script>element is completed, the next element may then be processed. For slower network environments, or websites containing a large amount of scripts, this means that display of the page will be delayed.

FIG. 1B illustrates a conventional processing timing diagram of a Deferred script <script defer>.

In FIG. 1B, line 1 represents a timeline of parsing webpage text, line 2 represents a timeline of loading a <script defer>element, and line 3 represents a timeline of executing a <script defer>element.

As shown in FIG. 1B, for processing the script having the Defer attribute, after parsing of the HTML document continues, to be completed while loading the script, the script may then be executed.

FIG. 1C illustrates a conventional processing timing diagram of an asynchronous script <script async>.

In FIG. 1C, line 1 represents a timeline of parsing webpage text, line 2 represents a timeline of loading a <script async>, and line 3 represents a timeline of executing a <script aspic>element.

As shown in FIG. 1C, parsing of the script having the asynchronous attribute also continues while the script is being loaded, but unlike the defer attribute, the script is immediately executed after loading of the script is completed.

As can be seen from the above timing diagrams, when executing the common script, parsing of the HTML document is suspended while loading and executing the JavaScript script, thereby resulting in the delay of the page display.

### BRIEF SUMMARY OF THE DISCLOSURE

In view of the abovementioned problems, the objective of the present disclosure is to provide method, device, and mobile terminal for a webpage text parsing. The disclosed method, device, and mobile terminal are directed to reduce the time of parsing, loading, and rendering the whole webpage, and allow elements behind common JavaScript script elements to be rendered and displayed in advance.

According to one aspect of the present disclosure, the present disclosure provides a method for webpage text parsing. The method includes:

When a currently-parsed webpage element is determined to be a common JavaScript script, the common JavaScript script is loaded to obtain an execution file of the common JavaScript script, and a DOM tree node corresponding to the common JavaScript script is constructed;

After loading of the common JavaScript script is completed, the execution file of the common JavaScript script is executed; and

After construction of the DOM tree node corresponding to the common JavaScript script is completed, the next webpage element is parsed.

After the currently-parsed webpage element is determined to be the common JavaScript script, the method further includes:

Marking the position of the common JavaScript script in the DOM tree; and

Executing a JavaScript execution file of the common JavaScript script includes:

According to the position of the common JavaScript script in the DOM tree, executing the execution file of the common JavaScript script.

Further including: when the JavaScript execution file that executes the common JavaScript script is to execute document writing, parsing a corresponding independent DOM tree structure generated by a JavaScript code of the execution file, and writing to the markup position.

Further including: when the JavaScript execution file of the common JavaScript script is to execute access or operation of the DOM node, the DOM node before the marked position can only be allowed to access or operate.

Before executing the JavaScript execution file of the common JavaScript script, further including:

Creating an execution task for executing the JavaScript execution file; and

Adding the execution task into an execution task queue. The execution method of the execution task in the execution task queue is that after execution of the last task is completed the next task may then be executed.

Further including: when parsing of the webpage element, of the current webpage text is determined not to be completed, the next element may then be parsed.

According to another aspect of the present disclosure, the present disclosure also provides a device for webpage text parsing including:

A parsing unit, configured to parse webpage elements of webpage text;

A DOM tree constructing unit, configured to construct a DOM tree node corresponding to the common JavaScript script, when the currently-parsed webpage element being parsed is determined to be a common JavaScript script;

A loading unit, configured to load the common JavaScript script to obtain an execution file of the common JavaScript script, when the currently-parsed webpage element is determined to be the common JavaScript script; and

An executing unit, configured to execute the execution file of the common JavaScript script, after the common JavaScript script is loaded.

Further including: a marking unit, configured to mark the position of the common JavaScript script in the DOM tree.

Further including: a parsing subunit, configured to parse a corresponding independent DOM tree structure generated by a JavaScript code of the execution file, when the JavaScript execution file that executes the common JavaScript script is to execute document writing; and

A text writing unit, configured to write the corresponding independent DOM tree structure, generated by the JavaScript code of the execution file that is parsed by the parsing subunit, into the position marked by the marking unit.

The present disclosure also provides a mobile terminal, including: a device for webpage text parsing and a device for rendering;

The device for webpage text parsing further includes:

A parsing unit, configured to parse webpage elements of webpage text

A DOM tree constructing unit, configured to construct a DOM tree node corresponding to the common JavaScript script, when the currently-parsed webpage element is determined to be a common JavaScript script;

A loading unit, configured to load the common JavaScript script to obtain an execution file of the common JavaScript script, when the currently-parsed webpage element is determined to be the common JavaScript script;

An executing unit, configured to execute the execution file of the common JavaScript script, after the common JavaScript is loaded;

A rendering device, configured to render the webpage for display, according to the DOM tree parsed by the webpage text parsing device.

The disclosed webpage text parsing method, device and mobile terminal, after parsing the webpage element to the JavaScript script, load the common JavaScript script and meanwhile construct the DOM tree node corresponding to the common JavaScript script. The common JavaScript script is executed, after loading of the common JavaScript script is completed. The next webpage element is parsed, after construction of the DOM tree node corresponding to the common JavaScript script is completed. While loading and executing the common JavaScript script, constructing the DOM tree node corresponding to the common JavaScript script and parsing the next webpage element are still continued to accelerate webpage text processing, thus, reducing the time of parsing, loading, rendering, and displaying the whole webpage, and also allowing the elements behind the common JavaScript script element to be rendered and displayed in advance.

In order to achieve the above and related objects, one or more aspects of the present disclosure include technical features described in details hereinafter and specifically indicated in claims. Some exemplified aspects of the present disclosure are elaborated in the following description and with reference to the drawings. However, the exemplified aspects of the present disclosure only show some of a variety of modes to apply the principle of the present disclosure. In addition, the present disclosure is intended to include all the aspects and their equivalents.

### BRIEF DESCRIPTION OF THE DRAWINGS

These and other objectives and advantages of the present disclosure will be more readily apparent from the following detailed description with reference to the drawings and the contents of the claims. In the drawings:

FIG. 1A illustrates a conventional processing timing diagram of a common JavaScript script <script>

FIG. 1B illustrates a conventional processing timing diagram of a Deferred script <script defer>:

FIG. 1C illustrates a conventional processing timing diagram of an asynchronous script <script async>;

FIG. 2 illustrates a flow chart of an exemplary webpage text parsing method of the present disclosure;

FIG. 3 illustrates a flow chart of another exemplary webpage text parsing method of the present disclosure;

FIG. 4 illustrates a flow chart of another exemplary webpage text parsing method of the present disclosure;

FIG. 5A illustrates a timing diagram of an existing asynchronous JavaScript, script <script aspic>, asynchronously processing two asynchronous script elements;

FIG. 5B illustrates an exemplary timing diagram of processing two common JavaScript scripts of embodiments in FIG.4;

FIG. 6 illustrates an exemplary DOM tree structure generated after an HTML text is parsed;

FIG. 7 illustrates a block diagram of an exemplary webpage text parsing device of the present disclosure;

FIG. 8 illustrates a block diagram of another exemplary webpage text parsing device of the present disclosure; and

FIG. 9 illustrates a structure block diagram of an exemplary mobile terminal of the present disclosure.

In all the figures, the same reference numerals indicate similar or corresponding features or functions.

### DETAILED DESCRIPTION

In the following the technical solutions of embodiments will be clearly and fully described hereinafter in combination with accompanying drawings.

The method and device of the present disclosure for webpage text parsing, may load and execute the common JavaScript script after a webpage element is parsed into be a common JavaScript script, and meanwhile construct a DOM tree node corresponding to the common JavaScript script for parsing the next webpage element. While loading and executing the common JavaScript script, construction of the DOM tree node corresponding to the common JavaScript script and parsing of the next webpage element may be still continued to accelerate webpage text processing, allowing the JavaScript script to be rendered and displayed in advance, thus, reducing the time of parsing, loading, rendering, and displaying the whole webpage.

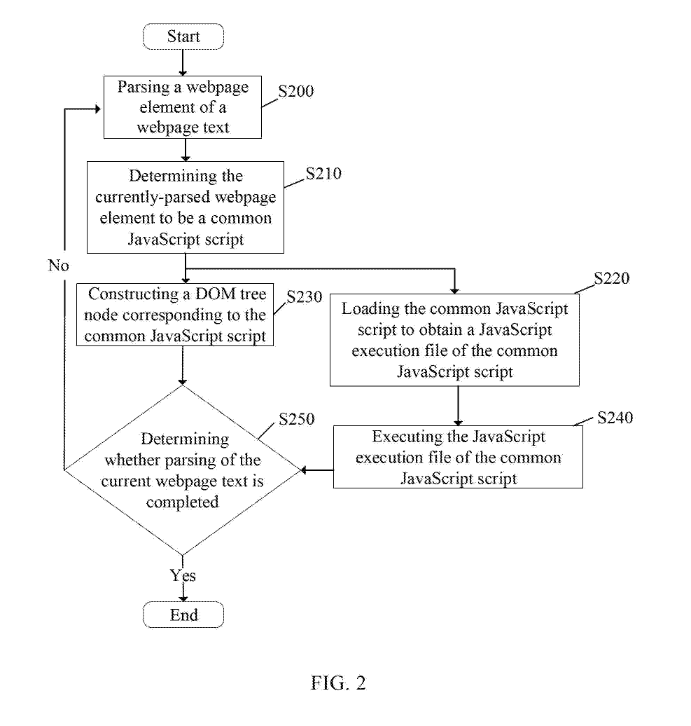

FIG. 2 illustrates a flow chart of an exemplary method of the present disclosure for webpage text parsing method.

As shown in FIG. 2, the method of the present disclosure for webpage text parsing may include:

Step S200, parsing webpage elements of webpage text.

Before rendering the webpage, a browser may first acquire the webpage text (i.e., the webpage source file) according to a user's request to a target website. After acquiring the webpage text, and then, the webpage text is parsed into a DOM tree. The browser may typeset and render the webpage according to a DOM tree structure. The webpage may simultaneously contain a plurality of webpage elements, such as webpage text, picture, JavaScript script file and the like. If the webpage element is the JavaScript script file, a corresponding process may need to be performed according to the type of the JavaScript script file.

Step S210, determining the currently-parsed webpage element to be the common JavaScript script.

When a webpage element of the webpage text is parsed, the browser may first parse HTML markup information of the element, and when the webpage element is parsed into a <script>tag, it may be regarded as the common JavaScript script.

After the current webpage element is determined to be the common JavaScript script, Step S220 and Step S230 may be executed simultaneously.

S220, loading, the common JavaScript script to obtain a JavaScript execution file of the common JavaScript script. Herein, loading the common JavaScript script is to acquire the JavaScript execution file of the common JavaScript script from a webpage server.

Step S230, constructing the DOM tree node corresponding to the common JavaScript script

After Step S220 is completed. Step S240 may be implemented to execute the JavaScript execution file of the common JavaScript script.

After the JavaScript file of the common JavaScript script is acquired, the JavaScript file may be executed. Herein, execution of the JavaScript file may include execution of certain operations or relevant execution of the current DOM tree structure.

After Step S230 is completed, Step S250 may be implemented to determine whether the parsing of the current webpage text is completed. If parsing is not completed, Step S200 may be implemented.

The method of the present embodiment for webpage text parsing, may load the common JavaScript script after the webpage element is parsed into the common JavaScript script, and meanwhile construct the DOM tree node corresponding to the common JavaScript script. The common JavaScript script is executed, after loading of the common JavaScript script is completed. The next webpage element is parsed, after construction of the DOM tree node corresponding to the common JavaScript script is completed. While loading and executing the common JavaScript script, construction of the DOM tree node corresponding to the common JavaScript script and parsing of the next webpage element are still continued to accelerate webpage text processing, thus, reducing the time of parsing, loading, rendering, and displaying the whole webpage, and also allowing the elements behind the common JavaScript script element to be rendered and displayed in advance.

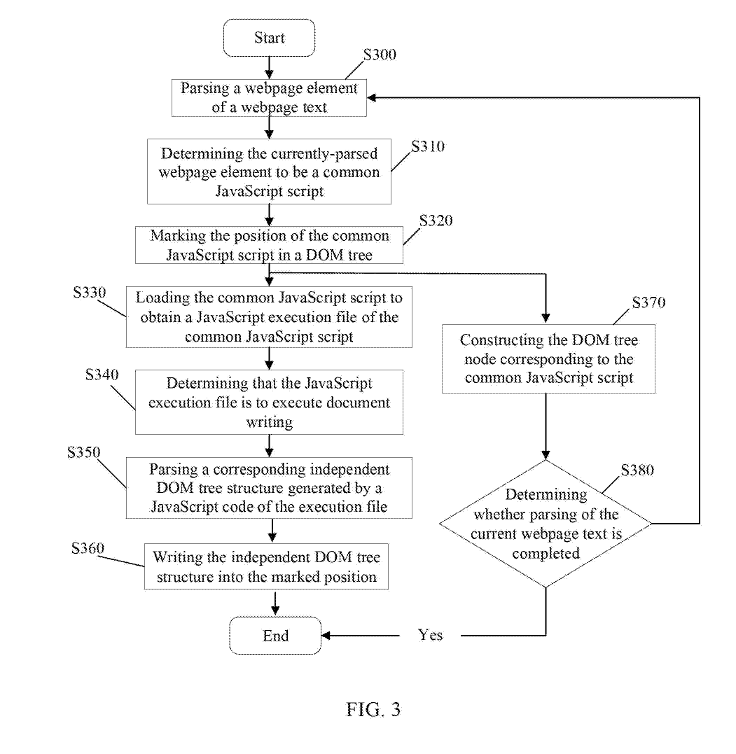

FIG. 3 illustrates a flow chart of another exemplary method of the present disclosure for webpage text parsing.

As shown in FIG. 3, the method of the present embodiment for webpage text parsing may include:

Step S300, parsing webpage elements of webpage text.

Step S310, determining the currently-parsed webpage element to be a common JavaScript script.

Step S300 and Step S310 of the present embodiment are the same as Step S200 and Step S210 of the last embodiment, respectively. The implementation process will not be described here.

Step S320, marking the position of the common JavaScript script in the DOM tree.

After Step S320 is completed, Step S330 may be executed to load the JavaScript execution file of the common JavaScript script.

Herein, loading the common JavaScript script is to acquire the JavaScript execution file of the common JavaScript script from a webpage, server.

Step S340, determining that the JavaScript execution file is to execute document writing.

After the JavaScript file of the common JavaScript script is acquired from the webpage server, the JavaScript execution file may be executed. At this point, the JavaScript execution file may be a JavaScript code. Herein, execution of the JavaScript execution file may include execution of certain operations or relevant execution of the current DOM tree structure. The relevant execution of the current DOM tree structure may include execution of document writing, that is, execution of “document.write” function, to write data stream of the function into data stream of the current webpage text. In other words, when the JavaScript execution file is the “document.write” function, the JavaScript execution file is determined to execute the document writing.

In order to keep the execution results consistent between the disclosed JavaScript script and the existing common JavaScript script, when the JavaScript execution file is determined to execute document writing, Step S350 may be executed to parse the corresponding independent DOM tree structure generated by the JavaScript code of the execution file. Because the execution file acquired from the webpage server is also an HTML statement that also needs to be parsed before rendering, the JavaScript code of the execution file acquired in Step S330 by loading the common JavaScript script needs to be parsed into an independent DOM structure.

After Step S350 is completed, Step S360 may be executed to write the independent DOM structure into the position marked in Step S320.

While executing Step S330 (i.e., loading the common JavaScript script), Step S370 may be executed to construct the DOM tree node corresponding to the common JavaScript script. After Step S370 is completed, Step S380 may be implemented to determine whether parsing of the current webpage text is completed. If parsing of the current, webpage text is completed, the program may end here. If parsing of the current webpage text is not completed, the program may return to Step S300 and continue to parse the webpage element of the webpage text.

Those skilled in the art may understand that Step S320 may be completed prior to Step S360, and Step S320 may be not limited to complete before Step S330 and Step S370.

In the present embodiment, after the common JavaScript script is loaded, the execution may execute the writing of document into the data stream of the current webpage text, that is, execute the “document.write” function. The writing may cause a change of the DOM tree structure corresponding to the current webpage text. On the other hand, in the prior art, when the common JavaScript is parsed, the common JavaScript script stops parsing (including construction of the DOM tree node of the common JavaScript script and parsing of the next element) to load, and execute the common JavaScript script. If writing into the data stream of the current webpage text is executed, the stopping position will be directly written. Because the parsing still continues in the present disclosure, in order to keep the execution results consistent between the disclosed JavaScript script and the existing common JavaScript script, the position of the common JavaScript script in the DOM tree needs to be, marked before execution, and after an HTML code in the writing function is parsed to the independent DOM structure, the previous markup position may be written.

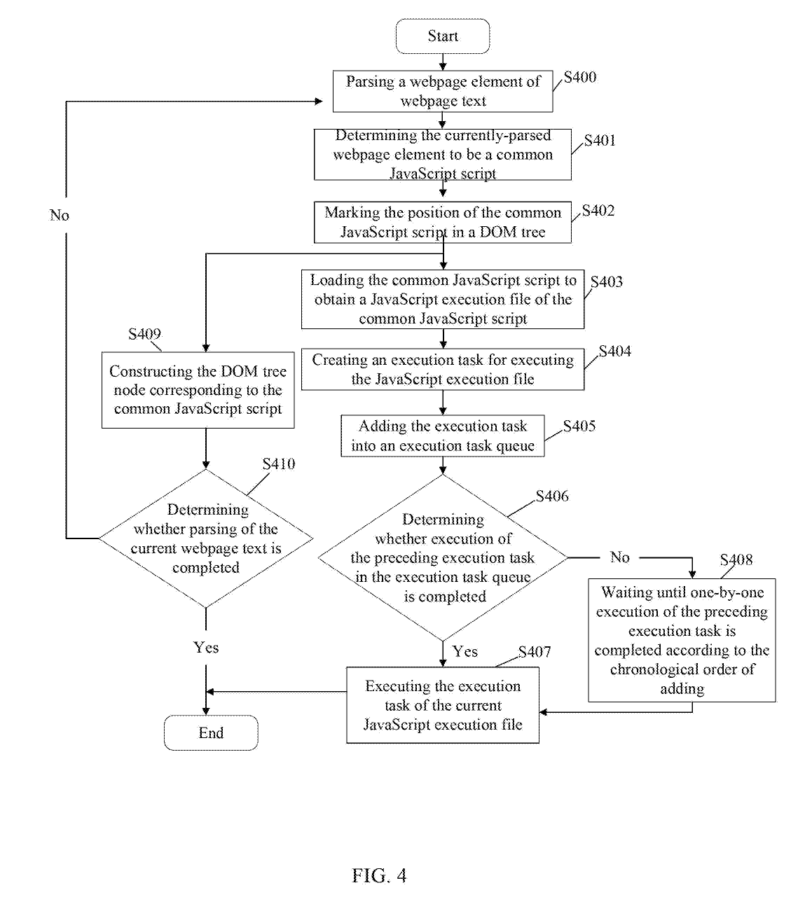

FIG. 4 illustrates a flow chart of another exemplary method of the present disclosure for webpage text parsing.

As shown in FIG. 4, the method of the present embodiment for webpage text parsing may include:

Step S400, parsing webpage elements of webpage text.

Step S401, determining the currently-parsed webpage element to be the common JavaScript script.

Step S402, marking the position of the common JavaScript script in the DOM tree.

After Step S402 is completed, Step S403 may be executed to load the common JavaScript script for acquiring the JavaScript execution file of the common JavaScript script.

Step S400, Step S401, Step S402, and Step S403 of the present embodiment are the same as Step S300, Step S310, Step S320, and Step S310 of the last embodiment, respectively. The implementation process will not be described here.

After Step S403 is completed and before the JavaScript execution file of the common JavaScript script is executed, Step S404 may be implemented to create and execute an execution task of the JavaScript execution file. The execution task may be added into an execution task queue (Step S405). After Step S404 and before Step S405, if the execution task queue has not been executed, the execution task queue may be created.

In Step S406, it can be determined whether execution of the execution task before the execution queue is completed. If the execution is completed, Step S407 may be implemented; if the execution is not completed. Step S407 may not be implemented until one-by-one execution of the preceding execution tasks is completed according to the chronological order of adding. The execution of the execution tasks in the execution task queue is one by one according to the chronological order of adding, the next execution task may not be executed until execution of the last execution task is completed.

Step S407, according to the position marked in Step S402, the execution task of the current JavaScript execution file is executed.

When the execution task of the JavaScript execution file is to access and operate the DOM node, the DOM node before the markup position may be allowed to access and operate, while the DOM node after the markup position may not be allowed to access and operate, which is for keeping the execution process results consistent between the disclosed JavaScript script and the existing common JavaScript script.

While executing Step S403 (i.e., loading the common JavaScript script is executed), Step S409 is also executed to construct the DOM tree node corresponding to the common JavaScript script. After Step S409 is completed, Step S410 may be implemented to determine whether parsing of the current webpage text is completed. If parsing of the current webpage text is completed, the process may end here. If parsing of the current webpage text is not completed, the process may return to Step S400 to continue parsing the webpage element of the webpage text.

Those skilled in the art may clearly understand that Step S402 may be completed prior to Step S407, and Step S402 may be not limited to complete before Step S403 and Step S408.

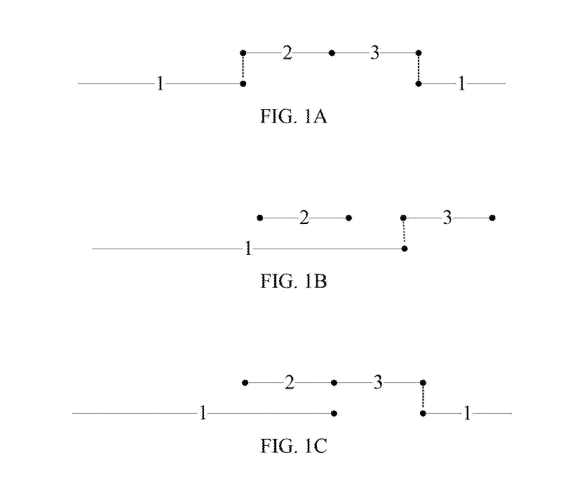

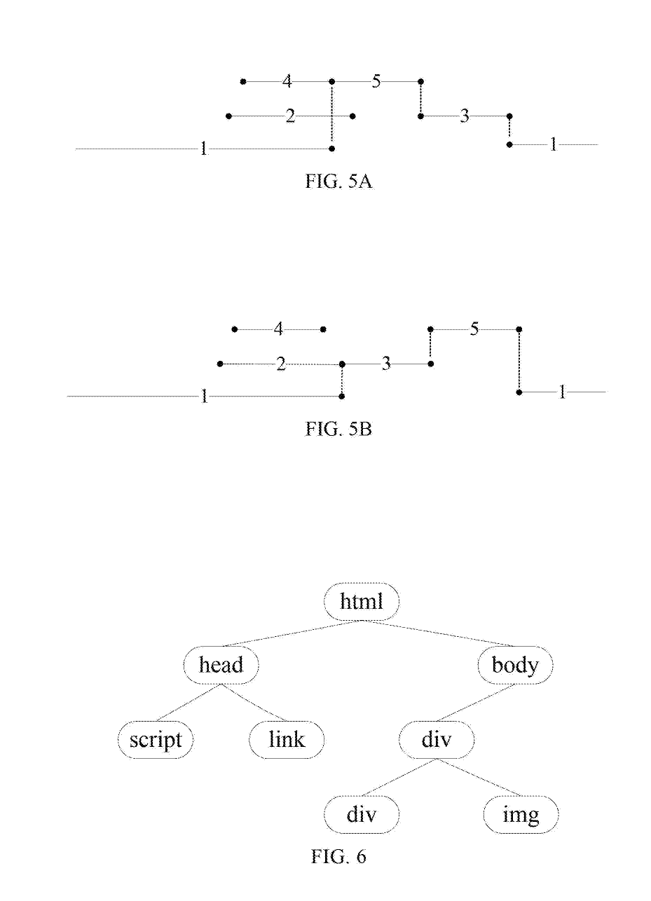

The process timing of the common JavaScript script of the present embodiment is asynchronous loading and synchronous executing. As shown in FIG. 1B, an asynchronous process timing of an existing asynchronous JavaScript script (i.e., <script async>) uses the script loading time to continue to parse and render, however, this type of process timing cannot guarantee the execution correctness for multiple relevant dependent scripts. For example, there are two external script files, script-A and script-B. Script-B needs to use the function defined in script-A. If the loading time of script-B is shorter than the loading time of script-A, then the process timing of <script async>will be shown in FIG. 5A.

FIG. 5A illustrates a timing diagram of an existing asynchronous JavaScript script <script async>, asynchronously processing two asynchronous script elements.

In FIG. 5A, line 1 represents the timeline of parsing the webpage text, line 2 represents the timeline of loading the script-A element, line 3 represents the timeline of executing the script-A, line 4 represents the timeline of loading the script-B element, and line 5 represents the timeline of executing the script-B element.

It can be found in FIG. 5A that if the process timing of <script async>is also applied to the common JavaScript script, then script-B will be first executed because the loading time of script-B is shorter than the loading time of script-A, which causes that script-B cannot access the function defined in script-A and the dependence between scripts are broken.

In the present embodiment, the process timing of the common JavaScript script is modified, as shown in FIG. 5B.

FIG. 5B illustrates an exemplary timing diagram of processing two common JavaScript scripts of embodiments in FIG. 4.

In FIG. 5B, line 1 represent the timeline of parsing the webpage text, line 2 represent the timeline of loading the script-A element, line 3 represents the timeline of executing the script-A element, line 4 represents the timeline of loading the script-B element, and line 5 represents the timeline of executing the script-B element.

As shown in FIG. 5B, the script-A element is first loaded and first added to the execution task queue, waiting for the loading of the script-A element and the script-B element. Regardless of whether loading of the script-B element is completed, the script-B element has to be executed after execution of the script-A element is completed. This process timing ensures that parsing and rendering are not blocked while loading the script, and meanwhile ensures that the dependence between multiple scripts is correct.

By means of the execution task queue, the present embodiment manages the execution order of the common JavaScript scripts and protects the webpage context content when the scripts are executed, thereby ensuring the execution results meet standards.

FIG. 6 illustrates an exemplary DOM tree structure generated after an HTML text is parsed.

As shown in FIG. 6, the link node and body node in the DOM tree as well as the child nodes (div, img) of the body node are nodes that have been parsed, and the corresponding nodes are created in the DOM tree. But for the script elements that are being executed, the link node and body node as well as the child nodes of the body node are not accessible. In order to ensure this feature, by means of the execution task queue, the present embodiment manages the execution order of the common JavaScript scripts and protect the webpage context content when the scripts are executed, thus ensuring the execution results meet the standards.

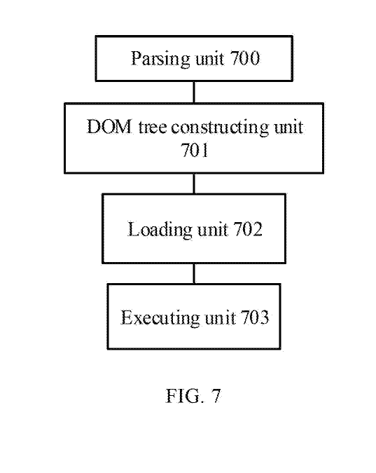

FIG. 7 illustrates a block diagram of an exemplary device of the present disclosure for webpage text parsing.

As shown in FIG. 7, the device of the present embodiment for webpage text parsing may include:

A parsing unit 700, configured to parse webpage elements of webpage text.

A DOM tree constructing unit 701, configured to construct the DOM tree node corresponding to the common JavaScript script, when the current webpage element is determined to be the common JavaScript script.

Before the webpage is rendered, a browser may first need to acquire the source files of the webpage text from the target site according to user request. After the webpage text is acquired, the webpage text may be parsed into a DOM tree. The browser may typeset and render the webpage according to the DOM tree structure. The webpage may include a plurality of webpage elements, such as webpage text, picture, JavaScript script and the like. If the webpage element is the JavaScript script file, then a corresponding process may need to be performed according to the type of the JavaScript script file.

When the parsing unit 700 parses a webpage element of the webpage text, the HTML markup information of the element is first parsed. When the webpage element is parsed into a <script>tag, the element may be regarded as the common JavaScript script

A loading unit 702, configured to load the common JavaScript script to obtain an execution file of the common JavaScript script, when the currently-parsed webpage element is determined to be the common JavaScript script.

Loading the common JavaScript script by the loading unit 702 is to acquire the JavaScript execution file of the common JavaScript script from a webpage server.

An executing unit 703, configured to execute the execution file of the common JavaScript script, after the common JavaScript script is loaded. Herein, the execution of JavaScript file may include execution of certain operations or relevant execution of the current DOM tree structure.

The webpage text parsing device of the present embodiment, after the parsing unit 700 parses the webpage element into the common JavaScript script, may load the common JavaScript script by the loading unit 702, and meanwhile may construct the DOM tree node corresponding to the common JavaScript script by the DOM tree constructing unit 701. After the loading unit 702 completes loading of the common JavaScript script, the common JavaScript script is executed by the executing unit 703. The next webpage element may be then parsed by the parsing unit 700, after the DOM tree constructing unit 701 completes construction of the DOM tree node corresponding to the common JavaScript script. While loading and executing the common JavaScript script, construction of the DOM tree node corresponding to the common JavaScript script and parsing of the next webpage element are still continued to accelerate webpage text processing, thus, reducing the time of parsing, loading, rendering, and displaying the whole webpage, and also allowing the elements behind the common JavaScript script element to be rendered and displayed in advance.

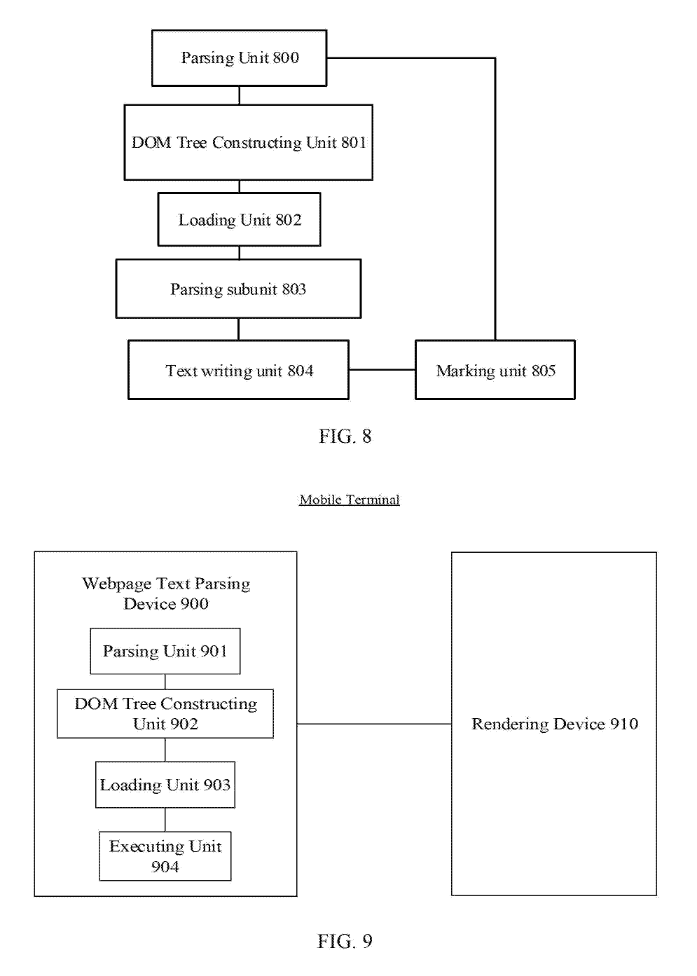

FIG. 8 illustrates a block diagram of another exemplary device of the present disclosure for webpage text parsing.

The parsing unit 800, the DOM tree constructing unit 801, and the loading unit 802 shown in FIG. 8 respectively correspond to the parsing unit 700, the DOM tree constructing unit 701, and the loading unit 702 of the last embodiment in implementation, function and principle, and they will not be described here.

The executing unit 703 of the last embodiment is replaced by a parsing subunit 803 and a text writing unit 804 in the present embodiment. And a marking unit 805 is also added.

The marking unit 805 may be configured to mark the position of the common JavaScript script in the DOM tree.

The parsing subunit 803, when the execution JavaScript code is a document writing function, may be configured to parse the JavaScript code in the function into an independent DOM structure.

The text writing unit 804 may be configured to write the independent DOM structure that is parsed by the JavaScript code in the function into the position marked by the marking unit 805.

After the loading unit 802 acquires the JavaScript file of the common JavaScript script from the webpage server, the JavaScript execution file may be executed. At this point, the JavaScript execution file may be a JavaScript code. Herein, execution of the JavaScript execution file may include execution of certain operations or relevant execution of the current DOM tree structure. The relevant execution of the current DOM tree structure may include execution of document writing, that is, execution of “document.write” function, to write data stream of the function into data stream of the current webpage text. That is, when the JavaScript execution file is the “document.write” function, the JavaScript execution file is determined to execute the document writing.

In order to keep execution process results consistent between the disclosed JavaScript script and the existing common JavaScript script, because the execution file acquired from the webpage server is also an HTML statement, which also needs to be parsed before rendering, when the JavaScript execution file is determined to execute document writing, the parsing subunit 803 may parse the corresponding independent DOM tree structure generated by the JavaScript code of the execution file.

Afterwards, the independent DOM tree structure may be written by the text writing unit 804 into the position marked by the marking unit 805.

The webpage text parsing device of the present embodiment, when the common JavaScript script is to execute document writing, may first mark the position of the common JavaScript script while the parsing unit is parsing the common JavaScript scriptand then in execution, parse the HTML code in the execution function into the independent DOM structure, and write the independent DOM structure into the previous markup position, thus ensuring that the result of writing to the data stream is consistent with the result of the existing standard process.

FIG. 9 illustrates a structure block diagram of an exemplary mobile terminal of the present disclosure.

As shown in FIG. 9, the mobile terminal of the present disclosure may include: a device 900 for webpage text parsing and a device 910 for rendering;

The device 900 for webpage text parsing may include:

A parsing unit 901, configured to parse webpage elements of webpage text;

A DOM tree constructing unit 902, configured to construct the DOM tree node corresponding to the common JavaScript script, when the currently-parsed webpage element is determined to be the common JavaScript script;

A loading unit 903, configured to load the common JavaScript script to obtain the execution file of the common JavaScript script, when the webpage element is determined to be the common JavaScript script;

An executing unit 904, configured to execute the execution file of the common JavaScript script, after loading of the common JavaScript script is completed;

A rendering device 900, configured to render the webpage for display according to the DOM tree parsed by the device for webpage text parsing.

The parsing unit 901, the DOM tree constructing unit 902, the loading unit 903, and the executing unit 904 of the device for webpage text parsing respectively corresponds to the parsing unit 701, the DOM tree constructing unit 702, the loading unit 703, and the executing unit 704 in function, and they will not be described here. Those skilled in the art can also be further aware that respective exemplary units and algorithm steps as described in conjunction with the embodiments of the present application may be implemented as electronic hardware such as a processor, computer software, or a combination of both. As to whether the functions are implemented in hardware or software, it depends on a specific application and a design constraint condition applied on the technical solution. Those skilled in the art may implement the depicted functions in a different manner for each specific application. However, such an implementation should not be construed as departing from the protection scope of the present disclosure.

Those skilled in the art may clearly understand that, to describe conveniently and simply, for specific working processes of the system, the apparatus, and the unit described in the foregoing, reference may be made to corresponding processes in the foregoing method embodiments, which are not repeated here.

In several embodiments of the present disclosure, it should be understood that the disclosed system, apparatus, and method may be implemented in other ways. For example, the apparatus embodiments described in the following are only exemplary, for example, the unit division is only logic function division, and there maybe other division ways during practical implementation, for example, multiple units or components may be combined or integrated into another system, or some features may be omitted or may not, be executed. In addition, the shown or discussed mutual couplings or direct couplings or communication connections maybe implemented through some interfaces. Indirect couplings or communication connections between apparatuses or units may be electrical, mechanical, or in other forms.

The units described as separated parts may or may not be physically separated from each other, and the parts shown as units may or may not be physical units, that is, they may be located at the same place, and may also be distributed to multiple network elements. A part or all of the units may be selected according to an actual requirement to achieve the objectives of the solutions in the embodiments.

In addition, function units in the embodiments of the present disclosure may be integrated into a processing unit, each of the units may also exist separately and physically, and two or more units may also be integrated into one unit. The integrated unit maybe implemented in the form of hardware, and may also be implemented in the form of a software function unit.

If the integrated unit is implemented in the form of a software function unit and is sold or configured as an independent product, it may be stored in a computer readable storage medium. Based on such understanding, the technical solutions of the present disclosure essentially, or the part contributing to the prior art, or all or a part of the technical solutions may be implemented in the form of a software product. The computer software product is stored in a storage medium and includes several instructions for instructing a computer device (which may be a personal computer, a server, or a network device, and so on.) to execute all or a part of steps of the methods described in the embodiments of the present disclosure. The storage medium includes: any medium that is capable of storing program codes, such as a USB-disk, a removable hard disk, a read-only memory (Read-Only Memory, referred to as ROM), a random-access memory (Random Access Memory, referred to as RAM), a magnetic disk, or an optical disk.

Although the present disclosure has been disclosed together with the preferred embodiments which is shown and described in detail, those skilled in the art should understand that various improvements can be made to the above described embodiments, without departing from the contents of the present disclosure. Therefore, the scope of the present disclosure should be determined by the claims.

1. A method for webpage text parsing, comprising:
determining a currently-parsed webpage element is a common JavaScript script, then loading the common JavaScript script to obtain an execution file of the common JavaScript script and simultaneously constructing a DOM tree node corresponding to the common JavaScript script;
after loading of the common JavaScript script is completed, executing, the execution file of the common JavaScript script; and
after construction of the DOM tree node corresponding to the common JavaScript script is completed, parsing a next webpage element.

2. The method :rot webpage text parsing according to claim 1, after determining the currently-parsed webpage element is the common JavaScript script, further including:
marking a position of the common JavaScript script in a DOM tree, wherein executing the execution file of the common JavaScript script includes:
executing the execution file of the common JavaScript script according to the position of the common JavaScript script in the DOM tree.

3. The method for webpage text parsing according to claim 2, further including:
parsing a JavaScript code of the execution file to generate a corresponding independent DOM tree structure and to write into the marked position, when execution of the execution file of the common JavaScript script is to execute document writing.

4. The method for webpage text parsing according to claim 2, further including:
only allowing to access or operate a DOM node before the marked position, when executing the execution file of the common JavaScript script is to execute access or operation of the DOM node.

5. The method for webpage text parsing according to claim 3, before executing the JavaScript execution file of the common JavaScript script, further including
creating, an execution task for executing the JavaScript execution file; and
adding the execution task into an execution task queue, wherein an execution method of the execution task in the execution task queue includes:
after executing a preceding execution task is completed, executing a next execution task.

6. The method for webpage text parsing according to claim 5, further including:
parsing the next webpage element, after parsing of a webpage element of a current webpage text is determined uncompleted.

7. A device for webpage text parsing, comprising:
a parsing unit, configured to parse a webpage element of webpage text;
a DOM tree constructing unit, when a currently-parsed the webpage element is determined to be a common JavaScript script, configured to construct a DOM tree node corresponding to the common JavaScript script.;
a loading unit, when a currently-parsed the webpage element is determined to be a common JavaScript script, configured to load the common JavaScript script to obtain an execution file of the common JavaScript script; and
an executing unit, after the common JavaScript script is loaded, configured to execute the execution file of the common JavaScript script.

8. The device for webpage text parsing according to claim 7, further including:
a marking unit, configured to mark a position of the common JavaScript script in a DOM tree,

9. The device for webpage text parsing according to claim 7, further including:
a parsing subunit, when execution of the JavaScript execution file of the common JavaScript script is to execute document writing, configured to parse a corresponding independent DOM tree structure generated by a JavaScript code of the execution file: and
a text writing unit, configured to write the corresponding independent DOM tree structure, generated by the JavaScript code of the execution file and parsed by the parsing subunit, into the position marked by the marking unit.

10. A mobile terminal, comprising:
a device for webpage text parsing, including
a parsing unit, configured to parse a webpage element of webpage text;
a DOM tree constructing unit, when the currently-parsed webpage element is determined to be a common JavaScript script, configured to construct a DOM tree node corresponding to the JavaScript script; and
a loading unit, when the currently-parsed webpage element is determined to be the common JavaScript, configured to load the common JavaScript script to acquire an execution file of the common JavaScript script; and
a rendering device, configured to render the webpage for display according to the DOM tree parsed by the device for a webpage text parsing.

11. The mobile terminal according to claim 10, further including:
a processor, and
a memory, having instructions stored thereon, the instructions executed by the at least one processor to control one or more of the device for webpage text parsing and the rendering device.

12. The mobile terminal according to claim 11, further including:
the memory includes a non-transitory computer-readable storage medium having instructions stored thereon.

13. The mobile terminal according to claim 11, wherein the processor is further configured to:
execute the execution file of the common JavaScript script after loading of the common JavaScript scrip is completed.

14. The mobile terminal according to claim 11, wherein the processor is further configured to:
mark a position of the common JavaScript script in a DOM tree, after the currently-parsed webpage element is determined as the common JavaScript script.

15. The mobile terminal according to claim 14, wherein the processor is further configured to:
parse a JavaScript code of the execution file to generate a corresponding independent DOM tree structure and to write into the marked position, when execution of the execution file of the common JavaScript script is to execute document writing.

16. The mobile terminal according to claim 15, wherein the processor is further configured to:
only allow to access or operate a DOM node before the marked position, when executing the execution file of the common JavaScript script is to execute access or operation of the DOM node.

17. The mobile terminal according to claim 16, wherein the processor is further configured to:
create an execution task for executing the JavaScript execution file, before executing the JavaScript execution file of the common JavaScript script; and
add the execution task into are execution task queue

18. The method for we page text parsing according to claim 4, before executing the JavaScript execution file of the, common JavaScript script, further including:
creating an execution task for executing the JavaScript execution file; and
adding the execution task into an execution task queue, wherein an execution method of the execution task in the execution task queue includes:
after executing a preceding execution task is completed, executing a next execution task.
